(19) United States
(12) Patent Application Publication
(10) Pub. No.: US 2009/0080206 A1
(43) Pub. Date: Mar. 26, 2009

(54) Marker lamps with camera

(75) Inventor: Feng Gao, Shanghai (CN)

Correspondence Address: BIRCH STEWART KOLASCH & BIRCH, PO BOX 747, FALLS CHURCH, VA, 22040-0747, US

(73) Assignee: Shanghai Star Custom Automobile Sales Co., Ltd, Shanghai (CN)

(21) Appl. No.: 12/232,262

(22) Filed: Sep. 12, 2008

(30) Foreign Application Priority Data
Sep. 14, 2007 (CN) 200720175895.8

(51) Int. Cl. B60Q 1/00

(52) U.S. Cl. 362/459

(57) ABSTRACT

The present invention provides a marker lamp with camera, which is installed on motor vehicle and comprises a power wire, a signal wire, a marker lamp unit and a camera; wherein the camera is installed within the said marker lamp. The camera is connected electrically with the power source through the said power wire, and with a display device through the said signal wire. The present invention renders the driver to see the scene behind the vehicle through images transmitted by the camera, so as to minimize the risk in driving and reduce potential traffic accidents.

### OBJECT OF THE INVENTION

The present invention relates to a lamp that is installed on vehicles, and more particularly, to a marker lamp (or width lamp) with camera.

### BACKGROUND OF THE INVENTION

Currently, rearview mirrors of motor vehicles present a large “blind area”. Drivers can hardly see other motor vehicles on the adjacent lanes when driving, and often change lanes when there are other cars in such “blind area”, which then leads to a traffic accident, causing scrape or even casualty, and bringing severe loss to the family and society.

### DESCRIPTION OF THE INVENTION

It is therefore an object of the present invention to overcome the deficiencies of the prior art by providing a marker lamp with camera, which enables drivers to see the scene behind the vehicle through images transmitted by the camera, so as to minimize the risk while driving and reduce potential traffic accidents.

To achieve the above mentioned object, the present invention provides a marker lamp with camera that is installed on motor vehicles, comprising a power wire, a signal wire, a marker lamp unit, and a camera, wherein the camera is installed within the said marker lamp unit and connected electrically with the power source through the said power wire, and with a display device through the said signal wire.

In one preferred embodiment of the present invention, the said power source is the battery of the motor vehicle or an external power source, and the said display device is the in-vehicle LCD monitor or is fixed on the rearview mirror; in addition, the said power wire may be provided with a switch which can be connected with the control device of the direction indicator or the control device of the back-up lamp.

The advantage of the invention is that, when driver needs to change lane while driving, he/she can either watches the signal images on the in-vehicle display transmitted from the camera or switches the in-vehicle LCD in advance. In this way, the “blind area” of the rearview mirror is eliminated, and road safety of vehicle is improved.

### DESCRIPTION OF THE DRAWINGS

FIG. 1 is a schematic view of the marker lamp with camera according to the present invention;

FIG. 2 is a structural view of the marker lamp with camera according to the present invention.

Description of reference number: power wire 1; signal wire 2; marker lamp unit 3; camera 4; power source 5; display device 6.

### PREFERRED EMBODIMENT OF THE INVENTION

The embodiment of the present invention will now be described below in detail with reference to the accompanying figures. The present invention provides a marker lamp with camera to replace the existing marker lamp of motor vehicles. The camera is installed within the marker lamp unit and used to shoot the scene behind the vehicle and transmit the images to driver's cab.

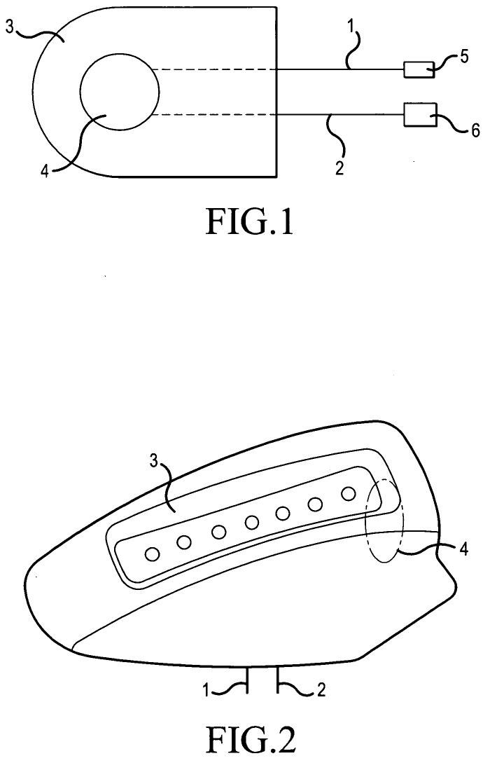

As shown in FIG. 1 and FIG. 2, the marker lamp with camera of the present invention comprises a power wire 1, a signal wire 2, a marker lamp unit 3 and a camera 4, wherein the marker lamp unit 3 can be that of the existing one on motor vehicles. The camera 4 is installed within the said marker lamp unit 3 and generally faces towards the back of the vehicle so as to shoot the scene there. More preferably, the camera 4 shoots the “blind area” behind the vehicle, which the drive cannot see through a rearview mirror.

The camera 4 is connected electrically to a power source 5 through the said power wire 1, and the power source 5 supplies power to the camera 4. The power source 5 can be either the battery built in the vehicle or an external power source. Thus, the driver can see the scene behind the vehicle by using the camera 4.

The camera 4 is connected to a display device 6 through the said signal wire 2; therefore the camera 4 transmits image signals to the display device 6 through the signal wire 2, and the shot scene is shown on the display device 6 for the driver. The display device 6 can be the internal monitor (including LCD monitor) of the vehicle, or it (or a small-sized LCD) can be installed on the rearview mirror, so the driver can see the rearview mirror and at the same time see the scene shot by the camera 4 through the display device 6, such as the “blind area” of the rearview mirror.

The above said camera 4 is directly connected to the power source 5 through the power wire 1. In practice, other configurations can be made according to different applications. For example, the power wire 1 may have a switch to control the power supply to the camera 4. In this way, if the camera is only needed when changing lanes for example, the switch can be connected and cooperated with the control device of the direction indicator. When the vehicle is ready to change lanes, the operation of direction indicator will trigger the switch to supply power to the camera 4, and therefore the driver can see the scene behind the vehicle without the “blind area” of rearview mirror and the safety is thereby improved. The switch can also be connected and cooperated with other devices, for instance, the control device of back-up lamp. In this way the driver can see the scene behind the vehicle by using camera 4 when reversing. With the additional help of the rearview mirror, reversing in this case can be as easy as forward moving.

While the present invention has been particularly shown and described with reference to the exemplary embodiments thereof, it will be understood by those skilled in the art that various changes in form and details can be made therein without departing from the spirit and scope of the present invention as defined by the following claims.

We claim:

1. A marker lamp with camera which is installed on motor vehicle, characterized in that the marker lamp comprises a power wire, a signal wire, a marker lamp unit and a camera; wherein the camera is installed within the said marker lamp unit, and connected electrically with the power source through the said power wire, and with a display device through the said signal wire.

2. The marker lamp with camera according to claim 1, characterized in that the said power source is the battery of the vehicle or an external power source.

3. The marker lamp with camera according to claim 1, characterized in that the said display device is an LCD monitor in the vehicle.

4. The marker lamp with camera according to claim 1, characterized in that the said display device is installed on rearview mirror.

5. The marker lamp with camera according to claim 1, characterized in that the said power wire has a switch.
